(19) United States
(12) Patent Application Publication
(10) Pub. No.: US 2026/0217517 A1
(43) Pub. Date: Jul. 30, 2026

(54) TOOL FOR DRAINING OIL AND/OR FUEL FROM AN OIL FILTER

(71) Applicant: Robert William Sloan, Maiden, NC (US)

(72) Inventor: Robert William Sloan, Maiden, NC (US)

(21) Appl. No.: 19/460,570

(22) Filed: Jan. 27, 2026

Related U.S. Application Data
(60) Provisional application No. 63/749,751, filed on Jan. 27, 2025.

(51) Int. Cl. B67B 7/00; F01M 11/04

(52) U.S. Cl. CPC B67B 7/26; F01M 11/04

(57) ABSTRACT

A tool for draining oil/fuel from an oil filter includes an elongated main body with a hammering end and a draining end on an opposite end. A draining spike protrudes from the draining end. The draining spike includes at least one spike hole. An extraction tube is connected to the draining spike and in communication with the spike holes. Whereby, when the draining spike is positioned against the oil filter on a low point of the oil filter, and the hammering end is hammered, the draining spike is configured to pierce a filter hole in the oil filter at the low point where the oil and/or the fuel from the oil filter drains through the at least one spike hole in the draining spike into the extraction tube. Wherein, the tool is configured to capture the oil/fuel from the oil filter and transfer it into a container.

### CROSS-REFERENCE TO RELATED APPLICATIONS

This application claims benefit to U.S. Provisional Ser. No. 63/749,751 filed on Jan. 27, 2025, entitled TOOL FOR DRAINING OIL AND OR FUEL FROM AN OIL FILTER, which is incorporated by reference in its entirety.

### FIELD OF THE DISCLOSURE

The present disclosure relates to engines requiring oil changes, oil filters for such engines, and removing oil and/or gas from such oil filters. More specifically, the present disclosure is directed to a tool for draining oil and/or fuel from an oil filter of such engines, like for transfer into approved recycling containers.

### BACKGROUND

Generally speaking, an engine or motor is a machine designed to convert one or more forms of energy into mechanical energy. The internal combustion engine is perhaps the most common example of a mechanical heat engine. An internal combustion engine (ICE or IC engine) is a heat engine in which the combustion of a fuel occurs with an oxidizer (usually air) in a combustion chamber that is an integral part of the working fluid flow circuit. In an internal combustion engine, the expansion of the high-temperature and high-pressure gases produced by combustion applies direct force to components of the engine. The force is typically applied to pistons (piston engine), turbine blades (gas turbine), a rotor (Wankel engine), or a nozzle (jet engine). This force moves the component over a distance. This process transforms chemical energy into kinetic energy which is used to propel, move or power whatever the engine is attached to.

Motor oil, engine oil, or engine lubricant is any one of various substances used for the lubrication of internal combustion engines. Motor oils typically consist of base oils enhanced with various additives, particularly anti-wear additives, detergents, dispersants, and, for multi-grade oils, viscosity index improvers. The main function of motor oil is to reduce friction and wear on moving parts and to clean the engine from sludge and varnish. It also neutralizes acids that originate from fuel and from oxidation of the lubricant, improves the sealing of piston rings, and cools the engine by carrying heat away from moving parts.

An oil filter is a filter designed to remove contaminants from engine oil, transmission oil, lubricating oil, or hydraulic oil. Their chief use is in internal-combustion engines for motor vehicles, powered aircraft, railway locomotives, ships and boats, and static engines such as generators and pumps. Other vehicle hydraulic systems, such as those in automatic transmissions and power steering, are often equipped with an oil filter. Gas turbine engines, such as those on jet aircraft, also require the use of oil filters. Oil filters are used in many different types of hydraulic machinery. The oil industry itself employs filters for oil production, oil pumping, and oil recycling. Modern engine oil filters tend to be full-flow (inline) or bypass oil filter systems.

The oil and the oil filter need to be periodically replaced. This standard process is typically referred to as an oil change. While there is an entire industry surrounding regular oil changes and maintenance, an oil change is a relatively simple car maintenance operation that many car owners can do themselves. It involves draining the oil from the engine into a drip pan, replacing the filter, and adding fresh oil. However, most localities require the used oil to be recycled after an oil change.

The instant disclosure recognizes the difficulties and problems associated with draining all of the oil and fuel in an oil filter prior to replacing the oil filter. The oil and/or fuel present in an oil filter may be extremely hot, which can lead to burns and bodily injury (fingers, hands, neck and/or chest) when not carefully removed. In addition, as oil filters are often at awkward angles and placements, the oil and/or fuel from an oil filter is often times spilled or leaked from the oil filter and/or engine when the oil filter is replaced. This can lead to contamination of the maintenance facility or surrounding environment like the ground, floor, and/or soil.

The instant disclosure may be designed to address at least certain aspects of the problems or needs discussed above by providing a tool for draining oil and/or fuel from an oil filter.

### SUMMARY

The present disclosure may solve the aforementioned limitations of the currently available means and/or mechanisms for conducting an oil change and replacing an oil filter, by providing the disclosed tool for draining oil and/or fuel from an oil filter. The disclosed tool for draining oil and/or fuel from an oil filter may generally include an elongated main body with a hammering end and a draining end. The draining end may be on an opposite end from the hammering end of the elongated main body. A draining spike may protrude from the draining end of the elongated main body. The draining spike may include at least one spike hole therethrough. An extraction tube may be connected to the draining spike. The extraction tube may be in communication with the at least one spike hole in the draining spike.

One feature of the disclosed tool for draining oil and/or fuel from an oil filter may be that when the draining spike is positioned against the oil filter, and the hammering end is hammered, the draining spike may be configured to pierce a filter hole in the oil filter. Although clearly not limited thereto, this filter hole may be ideally created with the tool at the low point of the oil filter for draining most if not all of the oil/fuel out of the oil filter. Wherein, when the draining spike pierces the oil filter, like at the low point, and is positioned inside of the oil filter through the filter hole, the oil and/or fuel from the oil filter may drain through the at least one spike hole in the draining spike into the extraction tube. Wherein, the tool may be configured and used to capture the oil and/or the fuel from the oil filter and transfer the captured oil and/or the captured fuel into a container by draining the oil and/or fuel from the oil filter, into and out of the extraction tube, and into the container, including, but not limited to, an approved recycling container for oil, fuel, or the like.

In select embodiments of the tool for draining oil and/or fuel from an oil filter, the at least one spike hole in the draining spike may include at least one bottom spike hole. The bottom spike hole or holes may be positioned approximate a bottom of the draining spike for draining most if not all of the oil or fuel from the oil filter. In select embodiments of the disclosed tool for draining oil and/or fuel from an oil filter, the at least one spike hole in the draining spike may include a plurality of spike holes therethrough the draining spike and in communication with the extraction tube. The plurality of spike holes in the draining spike may be configured to allow complete drainage of the oil and/or fuel from the oil filter. In select embodiments, the plurality of spike holes may include, but are not limited to: a first pair of bottom spike holes positioned approximate a bottom of the draining spike on opposite sides of the draining spike; a second pair of bottom spike holes positioned above the first pair of bottom spike holes on opposite sides of the draining spike; a first pair of middle spike holes positioned approximate a midpoint of the draining spike on opposite sides of the draining spike; and a second pair of middle spike holes positioned above the first pair of middle spike holes on opposite sides of the draining spike.

Another feature of the disclosed tool for draining oil and/or fuel from an oil filter may be that the draining spike can include a sharp distal end. The sharp distal end may be configured to pierce the oil filter or aid in piercing the oil filter when the tool is hammered on the hammering end. In select embodiments, the sharp distal end of the draining spike may include an angled tip. The angled tip of the draining spike may include, but is clearly not limited to, a chisel dual angled portion. The chisel dual angled portion may include a first long angled side, and a second short angled side. The second short angled side may be shorter than the first long angled side. Wherein, the first long angled side may be positioned at a cutting angle to the second short angled side. In select possibly preferred embodiments, he cutting angle created between the first long angled side and the second short angled side may be ninety degrees, or approximate thereto.

Another feature of the disclosed tool for draining oil and/or fuel from an oil filter may be the inclusion of a protruding rim at the draining end of the elongated main body. The protruding rim may be around the draining spike at the bottom of the draining spike. In select embodiments, a seal may be positioned on the protruding rim around the bottom of the draining spike. The seal may be configured to seal the protruding rim on the draining end of the tool to the oil filter when the draining spike is inserted into the oil filter and prevent leaks when the oil and/or the fuel is drained from the oil filter. In select embodiments, the seal may include, but is not limited to, a foam gasket, an O-ring member, the like, and/or combinations thereof. In select embodiments, the foam gasket may have a thickness of at least ½ inches or more for more dynamic penetrations of oil filter 16. As an example, and clearly not limited thereto, in select possibly preferred embodiments, the foam gasket may have a thickness of ½ inches.

Another feature of the disclosed tool for draining oil and/or fuel from an oil filter may be the inclusion of a magnetic positioning device. The magnetic positioning device may be included on the draining end of the elongated main body. The magnetic positioning device may be configured to position and hold the draining end of the elongated main body against the oil filter when the draining spike is inserted into the oil filter. In select possibly preferred embodiments, the magnetic positioning device may be a neodymium ring magnet. The neodymium ring magnet may be configured to securely hold the draining end of the elongated main body against the oil filter when the draining spike is inserted into the oil filter and the oil and/or the fuel is being drained from the oil filter into and out of the extraction tube. In select embodiments, the neodymium ring magnet may include an inside diameter of ⅜ inch that is positioned around the bottom of the draining spike.

In select embodiments of the disclosed tool for draining oil and/or fuel from an oil filter, the extraction tube may include a rigid portion. The rigid portion of the extraction tube may be integrally formed with the draining spike. The rigid portion of the extraction tube may extend from the draining spike through the elongated main body and out of the elongated main body at a tube passage approximate the hammering end of the elongated main body. In select embodiments, the rigid portion of the extraction tube integrally formed with the draining spike may be a stainless steel tube with an outside diameter of ⅜ inches. In select embodiments, the extraction tube may further include a flexible portion connected to the rigid portion. The flexible portion may be configured to be maneuverable for maneuvering a distal end of the extraction tube in relation to the elongated main body for inserting or removing the distal end of the extraction tube into or out of a container, like an approved recycling container for oil, fuel, or the like. In select embodiments, the flexible portion of the extraction tube may be clear flexible tubing with an inside diameter of ⅜ inches. In select embodiments, the flexible portion of the extraction tube may include a magnetic clip. The magnetic clip may be configured to attach and hold the distal end of the extraction tube in position on or in the container. In other select embodiments, the flexible portion of the extraction tube may include a clamp. The clamp may be configured to close the distal end of the extraction tube for controlling fluid flow out of the tool.

Another feature of the disclosed tool for draining oil and/or fuel from an oil filter may be that the hammering end of the elongated main body may include a hammerable member. In select embodiments, the hammerable member may include a flat surface with rounded sides.

Another feature of the disclosed tool for draining oil and/or fuel from an oil filter may be that the elongated main body may be a molded-on nylon main body. The molded-on nylon main body may include the hammerable member on the hammering end, the protruding rim on the draining end around the draining spike, and a tapered handle portion between the hammering end and the draining end. The tapered handle portion may be configured for gripping and manipulating the tool.

Another feature of the disclosed tool for draining oil and/or fuel from an oil filter may be that it can be configured and used to avoid burns and injury from hot oil/fuel being drained during an oil change and/or replacement of the oil filter.

Another feature of the disclosed tool for draining oil and/or fuel from an oil filter may be that it can be configured and used to avoid spillage/loss of used oil/fuel being drained during the oil change and/or the replacement of the oil filter.

Another feature of the disclosed tool for draining oil and/or fuel from an oil filter may be that it can be configured and used to avoid contamination of grounds/floors of used oil/fuel being drained during the oil chance and/or the replacement of the oil filter.

In another aspect, the instant disclosure embraces the disclosed tool for draining oil and/or fuel from an oil filter in any of the various embodiments and/or combinations of embodiments shown and/or described herein.

In another aspect, the instant disclosure embraces a method of performing an oil change and/or replacing an oil filter. The disclosed method of performing an oil change and/or replacing an oil filter may include utilizing the disclosed tool for draining oil and/or fuel from an oil filter in any of the various embodiments and/or combinations of embodiments shown and/or described herein. As such, the disclosed method of performing an oil change and/or replacing an oil filter may generally include providing the disclosed tool for draining oil and/or fuel from an oil filter in any of the various embodiments and/or combinations of embodiments shown and/or described herein, including, but not limited to, with: the elongated main body with the hammering end and the draining end on an opposite end of the hammering end of the elongated main body; the draining spike protruding from the draining end of the elongated main body, the draining spike including the at least one spike hole therethrough; and the extraction tube connected to the draining spike and in communication with the at least one spike hole in the draining spike. With the provided tool for draining oil and/or fuel from an oil filter, the disclosed method of performing an oil change and/or replacing an oil filter may also include the steps of: positioning the draining spike adjacent a low point on the oil filter; piercing a filter hole in the low point of the oil filter by hammering the hammering end of the tool; inserting the draining spike into the filter hole pierced in the low point of the oil filter; and draining the oil and/or fuel from the oil filter through the at least one spike hole in the draining spike into and out of the extraction tube into a container.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a partially broken away side view of the disclosed tool for draining oil and/or fuel from an oil filter according to select embodiments of the instant disclosure being positioned under an oil filter with the angled tip of the draining spike in position for piercing the low point of the oil filter;

FIG. 2 is a perspective view of the tool from FIG. 1 with the draining spike inserted into the low point of the oil filter for draining oil and/or fuel from the oil filter after being pierced by the angled tip of the draining spike and being held in position on the low point of the oil filter via the magnetic positioning device;

FIG. 3 is a perspective view of the oil filter from FIG. 2 after all of the oil and/or fuel from the oil filter is drained and the tool from FIG. 1 is removed, revealing the hole pierced in the low point of the oil filter; and

FIG. 4 is a flow chart for a method of performing an oil change and replacing an oil filter according to select embodiments of the instant disclosure utilizing the tool from FIG. 1.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

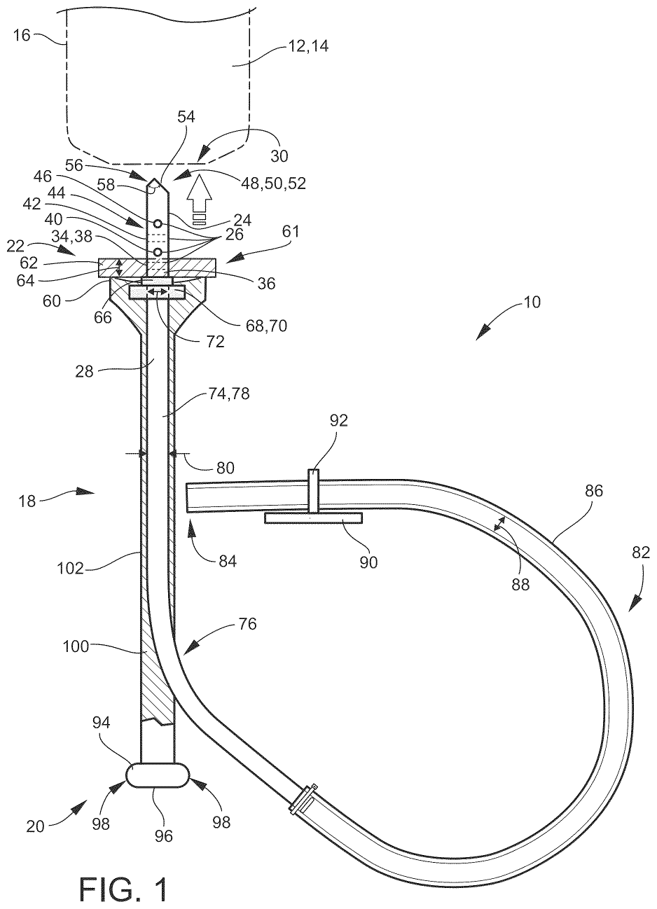

Referring now to FIGS. 1-4, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring to FIGS. 1-3, the present disclosure may solve the aforementioned limitations of the currently available means and/or mechanisms for conducting an oil change and/or replacing an oil filter by providing the disclosed tool 10 for draining oil 12 and/or fuel 14 from an oil filter 16. As used herein, the term draining oil 12 may include draining any fluid present in the oil filter 16 including oil 12 and/or fuel 14, or the like, or any other fluid present in oil filter 16. Tool 10 may thus be designed and configured for draining oil 12 and/or fuel 14 from oil filter 16, like when conducting an oil change and/or replacing oil filter 16, or the like. Tool 10 for draining oil 12 and/or fuel 14 from oil filter 16 may generally include elongated main body 18 with hammering end 20 and draining end 22. Draining end 22 may be on an opposite end from the hammering end 20 of elongated main body 18. Draining spike 24 may protrude from draining end 22 of elongated main body 18. Draining spike 24 may be a hollow protruding member extending from draining end 22 of elongated main body 18. Draining spike 24 may include at least one spike hole 26 or a plurality of spike holes 26 therethrough. Extraction tube 28 may be connected to draining spike 24. Extraction tube 28 may be in communication with each of the at least one spike hole 26 or plurality of spike holes 26 in the draining spike 24.

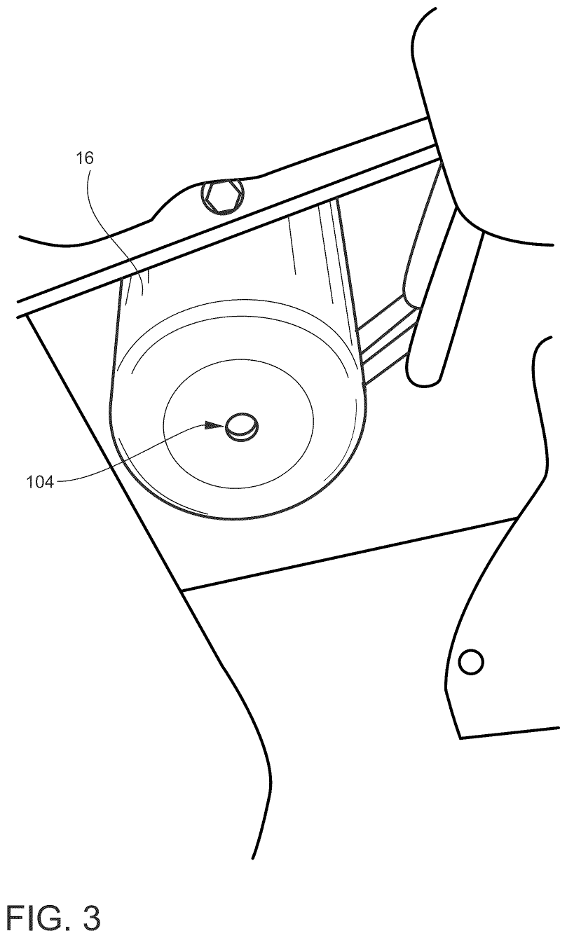

In use, as shown in FIGS. 1-3, draining spike 24 of tool 10 for draining oil 12 and/or fuel 14 from oil filter 16 may be positioned against oil filter 16. Hammering end 20 of elongated main body 18 may then be hammered, or the like, whereby draining spike 24 may be configured to pierce filter hole 104 in oil filter 16 (see FIG. 3). Although clearly not limited thereto, filter hole 104 may be ideally created with tool 10 at low point 30 of oil filter 16 for draining most if not all of the oil 12 and/or fuel 14 out of oil filter 16 via gravity. Wherein, when draining spike 24 pierces oil filter 16, including, but not limited to at low point 30, and draining spike 24 is positioned inside of oil filter 16 through filter hole 104 created or pierced therein, oil 12 and/or fuel 14 from oil filter 16 may drain through the at least one spike hole 26 or plurality of spike holes 26 in draining spike 24 into extraction tube 28. Distal end 84 of extraction tube 28 may be inserted into container 32, like an approved recycling container for oil, fuel, or the like, where oil 12 and/or fuel 14 may be extracted from oil filter 16 and drained through spike holes 26 of draining spike 24 into and out of extraction tube 28 and into container 32. Wherein, tool 10 may be configured and used to capture oil 12 and/or fuel 14 from oil filter 16 and transfer the captured oil 12 and/or the captured fuel 14 into container 32 by draining oil 12 and/or fuel 14 from oil filter 16, into and out of extraction tube 28, and into container 32, including, but not limited to, an approved recycling container for oil, fuel, or the like.

Draining spike 24 of tool 10 for draining oil 12 and/or fuel 14 from oil filter 16 may include any number and or location of spike holes 26 configured to drawing oil 12 and/or fuel 14 from oil filter 16. In select embodiments of tool 10, the at least one spike hole 26 in draining spike 24 may include at least one bottom spike hole 34. The bottom spike hole 34 or plurality of bottom spike holes 34 may be positioned approximate bottom 36 of draining spike 24 for draining most if not all of oil 12 or fuel 14 from oil filter 16. In select embodiments of tool 10, the at least one spike hole 26 in draining spike 24 may include a plurality of spike holes 26 therethrough draining spike 24 and in communication with extraction tube 28. The plurality of spike holes 26 in draining spike 24 may be configured to allow complete drainage of most if not all of oil 12 and/or fuel 14 from oil filter 16. In select embodiments, as shown in FIG. 1, the plurality of spike holes 26 may include, but are not limited to: first pair 38 of bottom spike holes 34 positioned approximate bottom 36 of draining spike 24 on opposite sides of draining spike 24; a second pair 40 of bottom spike holes 34 positioned above first pair 38 of bottom spike holes on opposite sides of draining spike 24; a first pair 42 of middle spike holes positioned approximate midpoint 44 of draining spike 24 on opposite sides of draining spike 24; and a second pair 46 of middle spike holes positioned above first pair 42 of middle spike holes on opposite sides of draining spike 24. In this embodiment, there may be a total of 8 spike holes 26 therethrough draining spike 24 for providing ample flow of oil 12 and/or fuel 14 from oil filter 16 and into tool 10.

Still referring to FIG. 1, another feature of tool 10 for draining oil 12 and/or fuel 14 from oil filter 16 may be that draining spike 24 can include sharp distal end 48. Sharp distal end 48 of draining spike 24 may be configured to pierce oil filter 16 for creating filter hole 104, or aid in piercing oil filter 16 for creating filter hole 104 when tool 10 is hammered on hammering end 20. Sharp distal end 48 of draining spike 24 may take any shape and/or configuration for piercing oil filter 16 for creating filter hole 104, or for aiding in piercing oil filter 16 for creating filter hole 104 when tool 10 is hammered on hammering end 20. In select embodiments, and clearly not limited thereto, sharp distal end 48 of draining spike 24 may include angled tip 50. Angled tip 50 of draining spike 24 may include, but is clearly not limited to, chisel dual angled portion 52, as shown in FIG. 1. Chisel dual angled portion 52 may include first long angled side 54, and second short angled side 56. Second short angled side 56 may be shorter than first long angled side 54. Wherein, first long angled side 54 may be positioned at cutting angle 58 to second short angled side 56. In select possibly preferred embodiments, as shown in FIG. 1, cutting angle 58 created between first long angled side 54 and second short angled side 56 may be ninety degrees, or approximate thereto.

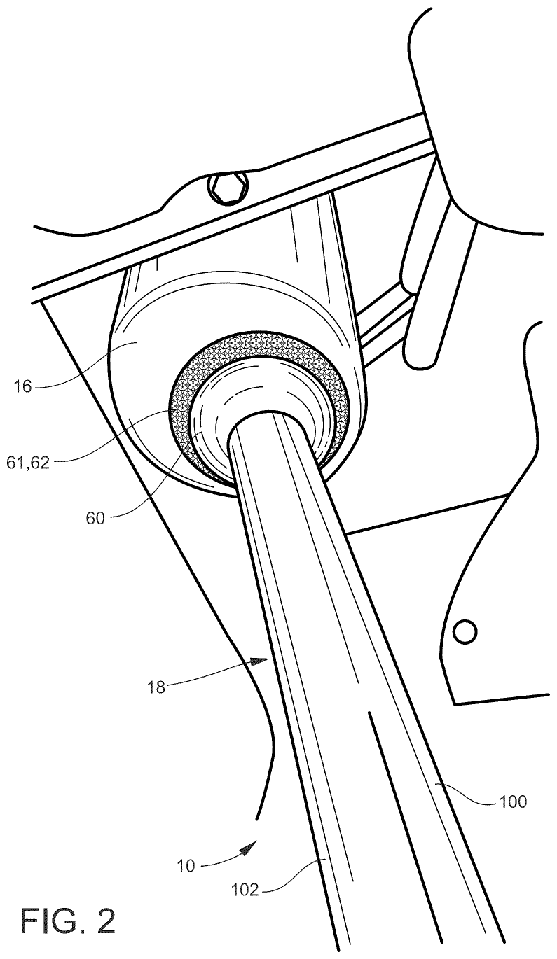

Referring now to FIGS. 1 and 2, another feature of tool 10 for draining oil 12 and/or fuel 14 from oil filter 16 may be the inclusion of protruding rim 60 at draining end 22 of elongated main body 18. Protruding rim 60, like a ledge or surface, may be around draining spike 24 at bottom 36 of draining spike 24. In select embodiments, seal 61 may be positioned on protruding rim 60 around bottom 36 of draining spike 24. Seal 61 may be configured to seal protruding rim 60 on draining end 22 of tool 10 to oil filter 16 when draining spike 24 is inserted into oil filter 16 and prevent leaks when oil 12 and/or fuel 14 is drained from oil filter 16. Seal 61 may include any device or means for sealing protruding rim 60 of tool 10 with oil filter 16 around draining spike 24. In select embodiments, as shown in FIGS. 1 and 2, seal 61 may include, but is not limited to, foam gasket 62, O-ring member 66, the like, and/or combinations thereof. Foam gasket 62 may include any shape or size for sealing protruding rim 60 on draining end 22 of tool 10 to oil filter 16 when draining spike 24 is inserted into oil filter 16 and prevent leaks when oil 12 and/or fuel 14 is drained from oil filter 16. In select embodiments, foam gasket 62 may have thickness 64 of at least ½ inches or more for more dynamic penetrations of oil filter 16. As an example, and clearly not limited thereto, in select possibly preferred embodiments, foam gasket 62 of seal 61 may have thickness 64 of ½ inches.

As best shown in FIG. 1, another feature of tool 10 for draining oil 12 and/or fuel 14 from oil filter 16, or the like, may be the inclusion of magnetic positioning device 68. Magnetic positioning device 68 may be included on draining end 22 of elongated main body 18. Magnetic positioning device 68 may be configured to position and hold draining end 22 of elongated main body 18 against oil filter 16 when draining spike 24 is inserted into oil filter 16. In select possibly preferred embodiments, magnetic positioning device 68 may be neodymium ring magnet 70, as shown in FIG. 1. Neodymium ring magnet 70 may be configured to securely hold draining end 22 of elongated main body 18 against oil filter 16 when draining spike 24 is inserted into oil filter 16 and oil 12 and/or fuel 14 is being drained from oil filter 16 into and out of extraction tube 28. In select embodiments, neodymium ring magnet 70 may include inside diameter 72 of ⅜ inch that be configured to be positioned around bottom 36 of draining spike 24.

Still referring to FIG. 1, in select embodiments of tool 10 for draining oil 12 and/or fuel 14 from oil filter 16, extraction tube 28 may include rigid portion 74. In select possibly preferred embodiments, rigid portion 74 of extraction tube 28 may be integrally formed with draining spike 24. Rigid portion 74 of extraction tube 28 may extend from draining spike 24 through elongated main body 18 and out of elongated main body 18 at tube passage 76 approximate hammering end 20 of elongated main body 18 (See FIG. 1). In select embodiments, rigid portion 74 of extraction tube 28 integrally formed with draining spike 24 may be stainless steel tube 78 with outside diameter 80 of ⅜ inches.

Still referring to FIG. 1, in select embodiments, extraction tube 28 may further include flexible portion 82 connected to rigid portion 74 of extraction tube 28. Flexible portion 82 may be configured to be maneuverable for maneuvering distal end 84 of extraction tube in relation to elongated main body 18, like for inserting or removing distal end 84 of extraction tube 28 into or out of container 32, like an approved recycling container for oil, fuel, or the like. In select embodiments, flexible portion 82 of extraction tube 28 may be clear flexible tubing 86 with inside diameter 88 of ⅜ inches. In select embodiments, flexible portion 82 of extraction tube 28 may include magnetic clip 90. Magnetic clip 90 may be configured to attach and hold distal end 84 of extraction tube 28 in position on or in container 32. Magnetic clip 90 may also be used for attaching flexible portion 82 of extraction tube 28 onto or with elongated main body 18 of tool 10, like for transport and/or storage. In select possibly preferred embodiments, magnetic clip 90 may be used for attaching flexible portion 82 of extraction tube 28 onto or with elongated main body 18 of tool 10 approximate draining end 22, like for transport and/or storage, to prevent drips or leaking while transporting and/or storing. In other select embodiments, flexible portion 82 of extraction tube 28 may include clamp 92. Clamp 92 may be configured to close distal end 84 (or approximate thereto) of extraction tube 28 for controlling fluid flow out of tool 10.

Still referring to FIG. 1, another feature of tool 10 for draining oil 12 and/or fuel 14 from oil filter 16 may be that hammering end 20 of elongated main body 18 may include hammerable member 94. In select embodiments, hammerable member 94 may include flat surface 96 with rounded sides 98. This embodiment of hammerable member 94 may allow for hammering draining spike 24 into oil filter 16 at various angles and in various positions.

Still referring to FIG. 1, another feature of tool 10 for draining oil 12 and/or fuel 14 from oil filter 16 may be that elongated main body 18 may be molded-on nylon main body 100, as shown. Molded-on nylon main body 100 may include hammerable member 94 on hammering end 20, protruding rim 60 on draining end 22 around draining spike 24, and tapered handle portion 102 between hammering end 20 and draining end 22. Tapered handle portion 102 may be configured for gripping and manipulating tool 10.

Another feature of tool 10 for draining oil 12 and/or fuel 14 from oil filter 16 may be that it can be configured and used to avoid burns and injury from hot oil 12 and/or/fuel 14 being drained during an oil change and/or replacement of oil filter 16.

Another feature of tool 10 for draining oil 12 and/or fuel 14 from oil filter 16 may be that it can be configured and used to avoid spillage/loss of used oil 12 and/or fuel 14 being drained during the oil change and/or the replacement of oil filter 16,

Another feature of tool 10 for draining oil 12 and/or fuel 14 from oil filter 16 may be that it can be configured and used to avoid contamination of grounds/floors of used oil 12 and/or fuel 14 being drained during the oil chance and/or the replacement of oil filter 16.

In another aspect, the instant disclosure embraces tool 10 for draining oil 12 and/or fuel 14 from oil filter 16 in any of the various embodiments and/or combinations of embodiments shown and/or described herein.

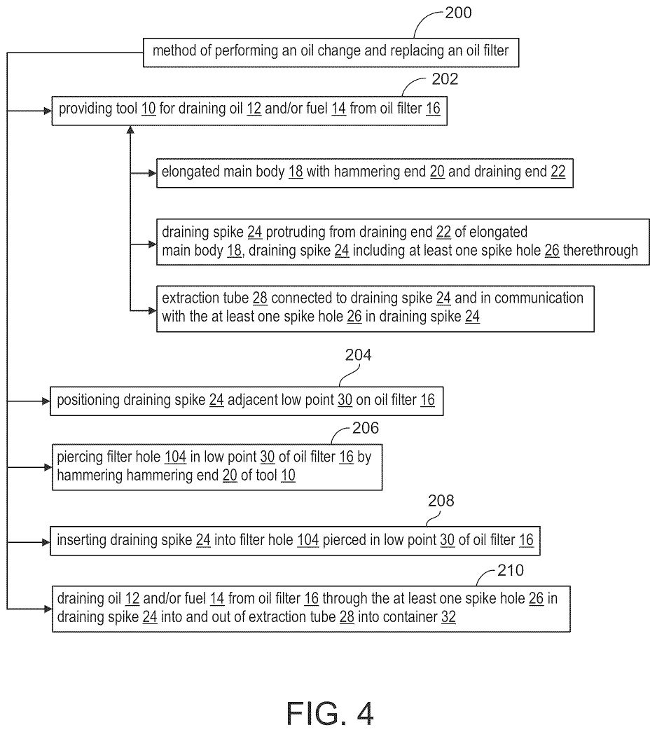

Referring now specifically to FIG. 4, in another aspect, the instant disclosure embraces method 200 of performing an oil change and/or replacing an oil filter, like oil filter 16. Method of performing an oil change and/or replacing oil filter 16 may include utilizing tool 10 for draining oil 12 and/or fuel 14 from oil filter 16 in any of the various embodiments and/or combinations of embodiments shown and/or described herein. As such, method 200 of performing an oil change and/or replacing oil filter 16 may generally include step 202 of providing tool 10 for draining oil 12 and/or fuel 14 from oil filter 16 in any of the various embodiments and/or combinations of embodiments shown and/or described herein, including, but not limited to, with: elongated main body 18 with hammering end 20 and draining end 22 on an opposite end of hammering end 20 of elongated main body 18; draining spike 24 protruding from draining end 22 of elongated main body 18, draining spike 24 including the at least one spike hole 26 therethrough; and extraction tube 28 connected to draining spike 24 and in communication with the at least one spike hole 26 in draining spike 24. With the provided tool 10 for draining oil 12 and/or fuel 14 from oil filter 16, method 200 of performing an oil change and/or replacing oil filter 16 may also include the steps of: step 204 of positioning draining spike 24 adjacent low point 30 on oil filter 16; step 206 of piercing filter hole 104 in low point 30 of oil filter 16 by hammering the hammering end 20 of tool 10; step 208 of inserting draining spike 24 into filter hole 104 pierced in low point 30 of oil filter 16; and step 210 of draining oil 12 and/or fuel 14 from oil filter 16 through the at least one spike hole 26 in draining spike 24 into and out of extraction tube 28 into container 32, like an approved recycling container for oil, fuel, gas, or the like.

As an example, and clearly not limited thereto, the disclosed tool 10 for draining oil 12 and/or fuel 14 from oil filter 16 may include: ⅜″ extruded stainless steel tubing 78 for creating rigid portion 74 of extraction tube 28 and draining spike 24; molded-on nylon main body 100; neodymium magnet 70 with inside diameter 72 of ⅜″; O-ring member 66 with an inside diameter of ⅜″; foam gasket 62 with an inside diameter of ⅜″ and thickness 64 of ½″; flexible clear tubing 86 for flexible portion 82 of extraction tube 28 with inside diameter 99 of ⅜″; and magnet/clip 90 to fasten flexible clear tube 86 to container 32.

A feature of the present disclosure may be its ability to avoid burns and injury from hot oil/fuel.

Another feature of the present disclosure may be its ability to avoid spillage/loss of used oil/fuel.

Another feature of the present disclosure may be its ability to avoid contamination of grounds/floors of used oil/fuel

In sum, the disclosed tool 10 for draining oil 12 and/or fuel 14 from oil filter 16 may be designed and/or configured to eliminate the problem of hot engine oil pouring on to fingers, hands, arms, neck and/or chest of an individual performing an oil change of engines. Additionally, the disclosed tool 10 for draining oil 12 and/or fuel 14 from oil filter 16 may be designed and/or configured to prevent the loss of oil to be recycled and/or oil contamination of floors/ground of maintenance facility or the like. The disclosed tool 10 for draining oil 12 and/or fuel 14 from oil filter 16 may work by tapping a hammer on hammering end 20 of elongated main body 18 while angled tip 50 of draining spike 24 may be positioned on any low point 30 of any oil filter 16, thereby piercing and opening a ⅜″ filter hole 104 and exposing old oil 12 in the filter 16 to pre-drilled spike holes 26 located at the draining end 22 of tool 10. Whereby, the oil 12 and/or fuel 14 from oil filter 16 may be allowed to escape through the aforementioned pre-drilled holes 26 through extraction tube 28 of tool 10, and into any approved oil recycling catch can or container 32. Neodymium ring magnet 70 may be molded into nylon main body 100 to facilitate stability during oil transfer from oil filter 16 through tool 10. Above neodymium magnet 70 may be foam gasket 62 and/or O-ring member 66 to hold and seal protruding rim around draining spike 24 onto the outer surface of oil filter 16.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A tool for draining oil from an oil filter comprising
an elongated main body with a hammering end and a draining end on an opposite end of the hammering end of the elongated main body;
a draining spike protruding from the draining end of the elongated main body, the draining spike including at least one spike hole therethrough; and
an extraction tube connected to the draining spike and in communication with the at least one spike hole in the draining spike.

2. The tool of claim 1, whereby, when the draining spike is positioned against the oil filter on a low point of the oil filter, and the hammering end is hammered, the draining spike is configured to pierce a filter hole in the oil filter at the low point;
wherein, when the draining spike pierces the low point of the oil filter and is positioned inside of the oil filter through the filter hole, the oil from the oil filter drains through the at least one spike hole in the draining spike into the extraction tube; and
wherein, the tool is configured to capture the oil from the oil filter and transfer the captured oil into a container.

3. The tool of claim 1, wherein the at least one spike hole in the draining spike including at least one bottom spike hole positioned approximate a bottom of the draining spike.

4. The tool of claim 1, wherein the at least one spike hole in the draining spike including a plurality of spike holes therethrough the draining spike and in communication with the extraction tube, the plurality of spike holes in the draining spike are configured to allow complete drainage and include:
a first pair of bottom spike holes positioned approximate a bottom of the draining spike on opposite sides of the draining spike;
a second pair of bottom spike holes positioned above the first pair of bottom spike holes on opposite sides of the draining spike;
a first pair of middle spike holes positioned approximate a midpoint of the draining spike on opposite sides of the draining spike; and
a second pair of middle spike holes positioned above the first pair of middle spike holes on opposite sides of the draining spike.

5. The tool of claim 1, wherein the draining spike including a sharp distal end configured to pierce the oil filter.

6. The tool of claim 5, wherein the sharp distal end of the draining spike including an angled tip.

7. The tool of claim 6, wherein the angled tip of the draining spike including a chisel dual angled portion, the chisel dual angled portion including:
a first long angled side;
a second short angled side, the second short angled side being shorter than the first long angled side; and
wherein, the first long angled side is positioned at a cutting angle the second short angled side, the cutting angle being ninety degrees.

8. The tool of claim 1, wherein the draining end of the elongated main body including:
a protruding rim around the draining spike at the bottom of the draining spike; and
a seal positioned on the protruding rim around the bottom of the draining spike, the seal is configured to seal the protruding rim on the draining end of the tool to the oil filter when the draining spike is inserted into the oil filter and prevent leaks when the oil is drained from the oil filter.

9. The tool of claim 8, wherein the seal including:
a foam gasket having a thickness of at least ½ inches or more;
an O-ring member; or
a combination thereof.

10. The tool of claim 1 further comprising a magnetic positioning device on the draining end of the elongated main body, the magnetic positioning device is configured to hold the draining end of the elongated main body against the oil filter when the draining spike is inserted into the oil filter.

11. The tool of claim 10, wherein the magnetic positioning device is a neodymium ring magnet configured to securely hold the draining end of the elongated main body against the oil filter when the draining spike is inserted into the oil filter and the oil is being drained from the oil filter into and out of the extraction tube; and
wherein the neodymium ring magnet includes an inside diameter of ⅜ inch that is positioned around the bottom of the draining spike.

12. The tool of claim 1, wherein the extraction tube including a rigid portion integrally formed with the draining spike, the rigid portion of the extraction tube extending from the draining spike through the elongated main body and out of the elongated main body at a tube passage approximate the hammering end of the elongated main body.

13. The tool of claim 12, wherein the rigid portion of the extraction tube is a stainless steel tube with an outside diameter of ⅜ inches.

14. The tool of claim 12, wherein the extraction tube further including a flexible portion connected to the rigid portion, the flexible portion is configured to be maneuverable for maneuvering a distal end of the extraction tube in relation to the elongated main body for inserting or removing the distal end of the extraction tube into or out of a container.

15. The tool of claim 14, wherein the flexible portion of the extraction tube being clear flexible tubing with an inside diameter of ⅜ inches, wherein the flexible portion of the extraction tube including:
a magnetic clip configured to attach and hold the distal end of the extraction tube in position on or in the container; and
a clamp configured to close the distal end of the extraction tube for controlling fluid flow out of the tool.

16. The tool of claim 1 wherein the hammering end of the elongated main body including a hammerable member, where the hammerable member including a flat surface with rounded sides.

17. The tool of claim 1, wherein the elongate main body is a molded-on nylon main body including a hammerable member on the hammering end, a protruding rim on the draining end around the draining spike, and a tapered handle portion between the hammering end and the draining end configured for gripping and manipulating the tool.

18. The tool of claim 1 being configured with the ability to:
avoid burns and injury from hot oil being drained during an oil change or replacement of the oil filter
avoid spillage or loss of used oil being drained during the oil change or the replacement of the oil filter; or
avoid contamination of grounds or floors of used oil being drained during the oil chance or the replacement of the oil filter.

19. A tool for draining oil from an oil filter comprising
an elongated main body with a hammering end and a draining end on an opposite end of the hammering end of the elongated main body, wherein the hammering end of the elongated main body including a hammerable member, where the hammerable member including a flat surface with rounded sides, wherein the elongate main body is a molded-on nylon main body including a hammerable member on the hammering end, a protruding rim on the draining end around the draining spike, and a tapered handle portion between the hammering end and the draining end configured for gripping and manipulating the tool;
a draining spike protruding from the draining end of the elongated main body, the draining spike including at least one spike hole therethrough, the draining spike including a sharp distal end configured to pierce the oil filter,
wherein the sharp distal end of the draining spike including an angled tip,
wherein the angled tip of the draining spike including a chisel dual angled portion, the chisel dual angled portion including:
a first long angled side;
a second short angled side, the second short angled side being shorter than the first long angled side; and
wherein, the first long angled side is ninety degrees to the second short angled side;
a plurality of spike holes therethrough draining spike and in communication with the extraction tube, the plurality of spike holes in the draining spike include:
a first pair of bottom spike holes positioned approximate a bottom of the draining spike on opposite sides of the draining spike;
a second pair of bottom spike holes positioned above the first pair of bottom spike holes on opposite sides of the draining spike;
a first pair of middle spike holes positioned approximate a midpoint of the draining spike on opposite sides of the draining spike; and
a second pair of middle spike holes positioned above the first pair of middle spike holes on opposite sides of the draining spike;
an extraction tube connected to the draining spike and in communication with the at least one spike hole in the draining spike, the extraction tube including:
a rigid portion integrally formed with the draining spike, the rigid portion of the extraction tube extending from the draining spike through the elongated main body and out of the elongated main body approximate the hammering end of the elongated main body, wherein the rigid portion of the extraction tube is a stainless steel tube with an outside diameter of ⅜ inches;
a flexible portion connected to the rigid portion, the flexible portion is configured to be maneuverable for maneuvering a distal end of the extraction tube in relation to the elongated main body for inserting or removing the distal end of the extraction tube into or out of a container, wherein the flexible portion of the extraction tube being clear flexible tubing with an inside diameter of ⅜ inches;
a magnetic clip configured to attach and hold the distal end of the extraction tube in position on or in the container; and
a clamp configured to close the distal end of the extraction tube for controlling fluid flow out of the tool
the draining end of the elongated main body including:
the protruding rim around the draining spike at the bottom of the draining spike; and
a seal positioned on the protruding rim around the bottom of the draining spike, the seal is configured to seal the protruding rim on the draining end of the tool to the oil filter when the draining spike is inserted into the oil filter and prevent leaks when the oil is drained from the oil filter, wherein the seal including a foam gasket having a thickness of at least ½ inches or more;
a magnetic positioning device on the draining end of the elongated main body, the magnetic positioning device is configured to hold the draining end of the elongated main body against the oil filter when the draining spike is inserted into the oil filter, wherein the magnetic positioning device is a neodymium ring magnet configured to securely hold the draining end of the elongated main body against the oil filter when the draining spike is inserted into the oil filter and the oil is being drained from the oil filter into and out of the extraction tube, wherein the neodymium ring magnet includes an inside diameter of ⅜ inch that is positioned around the bottom of the draining spike;
whereby, when the draining spike is positioned against to the oil filter and the hammering end is hammered, the draining spike is configured to pierce a filter hole in the oil filter;
wherein, when the draining spike pierces the filter hole in oil filter and is positioned inside of the oil filter through the filter hole, the oil from the oil filter drains through the at least one spike hole in the draining spike into the extraction tube; and
wherein, the tool is configured to capture the oil from the oil filter and transfer the captured oil into a container.

20. A method of performing an oil change and replacing an oil filter comprising:
providing a tool for draining oil from an oil filter comprising:
an elongated main body with a hammering end and a draining end on an opposite end of the hammering end of the elongated main body;
a draining spike protruding from the draining end of the elongated main body, the draining spike including at least one spike hole therethrough; and
an extraction tube connected to the draining spike and in communication with the at least one spike hole in the draining spike;
positioning the draining spike adjacent a low point on the oil filter;
piercing a filter hole in the low point of the oil filter by hammering the hammering end of the tool;
inserting the draining spike into the filter hole pierced in the low point of the oil filter; and
draining the oil from the oil filter through the at least one spike hole in the draining spike into and out of the extraction tube into a container.
